(19) United States
(12) Patent Application Publication
(10) Pub. No.: US 2008/0276175 A1
(43) Pub. Date: Nov. 6, 2008

(54) CONTENT PRODUCTION APPARATUS AND METHOD

(75) Inventors: Jung Hun KIM, Busan Metropolitancity City (KR); Young Ho Rhee, Seoul (KR); Jae Hwan Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/111,491

(22) Filed: Apr. 29, 2008

(30) Foreign Application Priority Data
May 4, 2007 (KR) 2007-0043599

(51) Int. Cl. G06F 3/00

(52) U.S. Cl. 715/723

(57) ABSTRACT

A content production apparatus and method provided for a user to produce a personal content using data collected while using a mobile terminal. The content production method includes displaying an theme selection screen listing subjects and templates associated with the subjects; displaying a content production screen including a content production window composed of a template associated with a subject selected on theme selection screen and items generated using user data; and producing content by arranging at least one of the items on the template.

### PRIORITY

This application claims priority under 36 U.S.C. §119(a) to an application entitled “CONTENT PRODUCTION APPARATUS AND METHOD” filed in the Korean Intellectual Property Office on May 4, 2007 and assigned Serial No. 2007-0043599, the contents of which are incorporated herein by reference.

### BACKGROUND OF THE INVENTION

1. Field of the Invention

The present invention relates to a mobile terminal and, in particular, to a content production apparatus and method for a mobile terminal that enable a user to produce a personal content using data collected while using a mobile terminal.

2. Description of the Related Art

With the advance of mobile communicating and wireless communication technologies, voice and data communications can be conducted anytime and anywhere. As coming centers of personal communication, mobile phones are beginning to incorporate various multimedia functionalities, such as a short message service function, a music player function, a digital camera function, and a gaming function, which result in a handling of various contents. The contents include voice recordings, text messages, audio sounds, still and motion pictures, and video clips.

Typically, such contents can be handled using a computer installed with applications provided by a mobile phone manufacturer or a service provider or accessed through a webpage provided by a web server of the service provider.

However, the conventional content producing system has very limited capabilities in producing and editing the contents. Accordingly, there is a need for a versatile content-handling technique for satisfying diverse user demands and preferences.

### SUMMARY OF THE INVENTION

The present invention has been made in an effort to solve the above problems, and the present invention provides a content production apparatus and method that are capable of improving content usability of user data collected by a mobile terminal.

Also, the present invention provides a content production apparatus and method that enable producing useful personal contents using user data associated with usage of a mobile terminal.

In accordance with an aspect of the present invention, the above and other objects are accomplished by a content production method. The content production method includes displaying an theme selection screen listing subjects and templates associated with the subjects; displaying a content production screen including a content production window composed of a template associated with a subject selected on theme selection screen and items generated using user data; and producing a content by arranging at least one of the items on the template.

Preferably, the content production window includes at least one of editable regions including a background music input region, a title input region, a tag input region, a still picture input region, a motion picture input region, and a text input region.

Preferably, the items include raw data items and processed data items obtained by processing the raw data items.

Preferably, the content production screen includes a raw data window arranged at a side of the content production window for listing the raw data items; a processed data window arranged at a side of the content production window for listing the processed data items; and a toolbar arranged at a side of the content production window for presenting tools.

Preferably, producing a content includes moving at least one of the items listed in the raw data window and processed data window onto the content production window in a drag and drop manner.

Preferably, producing content includes placing the dragged item at one of the editable regions.

Preferably, producing a content includes if the item is a music file, placing the item at the background music input region; if the item is a still picture, placing the item at the still picture input region; if the item is a motion picture, placing the item at the motion picture input region; and if the item is one of voice communication, short message, e-mail, memo, schedule, and personal information management system data, placing the item at the text input region.

Preferably, producing content includes if an editable region is selected, displaying an editing toolbox presenting tools that can be used in the editable region.

Preferably, the content production method further includes classifying and storing the produced contents by subject.

In accordance with another aspect of the present invention, the above and other objects are accomplished by a content protection apparatus. The content production method includes a theme selection screen provider for providing a theme selection screen listing subjects and templates associated with the subjects; a content production screen provider for providing a content production screen including a content production window composed of a template associated with a subject selected on theme selection screen and items generated using user data; and a content producer for producing a content by arranging at least one of the items on the template.

### BRIEF DESCRIPTION OF THE DRAWINGS

The above and other objects, features and advantages of the present invention will be more apparent from the following detailed description in conjunction with the accompanying drawings, in which:

FIG. 1 is a schematic diagram illustrating a content production system according to an exemplary embodiment of the present invention;

FIG. 2 is a block diagram illustrating a configuration of a content production apparatus of the content production system of FIG. 1;

FIG. 3 is a screen image illustrating a theme selection screen of a content production system according to an exemplary embodiment of the present invention;

FIG. 4 is a screen image illustrating a content production screen of a content production system according to an exemplary embodiment of the present invention;

FIG. 5 is an enlarged view illustrating the content production window of the content production screen of FIG. 4;

FIG. 6 is a view illustrating processes for editing an item presented in an editable region of the content production window using edit tools provided by the content production system according to an exemplary embodiment of the present invention;

FIG. 7A is a view illustrating processes for editing an item presented in an editable region using edit tools provided by the content production system according to an exemplary embodiment of the present invention;

FIG. 7B is a view illustrating processes for editing an item presented in an editable region using a hand tool provided by the content production system according to an exemplary embodiment of the present invention;

FIGS. 8A and 8B are views illustrating processes for adding a text balloon to an item presented in an editable region using text balloon tools provided by the content production system according to an exemplary embodiment of the present invention;

FIG. 9 is a flowchart illustrating a content production method according to an exemplary embodiment of the present invention; and

FIGS. 10 to 12 are screen images illustrating content production processes of a content production method according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the following embodiments, the content production apparatus and method are described with an example of a mobile terminal supporting cellular communication. The mobile terminal can be one of a cellular phone, a broadcast receiver, a Personal Digital Assistant (PDA), a laptop computer, a Personal Computer (PC), a Smartphone, a 3^{rd} Generation standard mobile terminal, a Code Division Multiple Access (CDMA) terminal, a Global System for Mobile communication (GSM) terminal, a Global Packet Radio Services (GPRS) terminal, a Wireless Local Area Network (WLAN) terminal, a Wireless Broadband (WiBro) Terminal, and a High Speed Downlink Packet Access (HSDPA) terminal, and their equivalents.

Content Production Apparatus

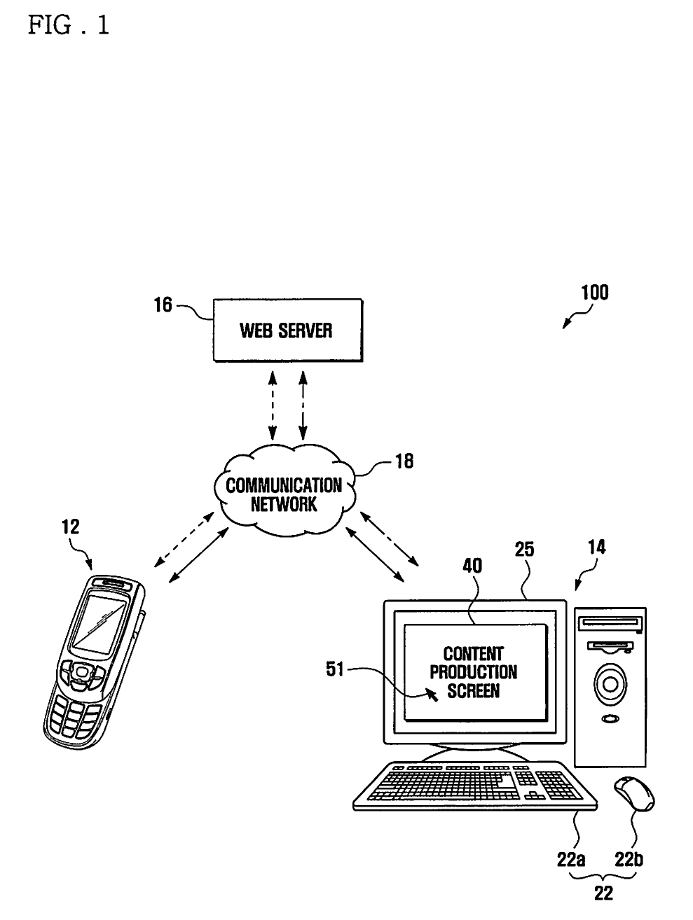

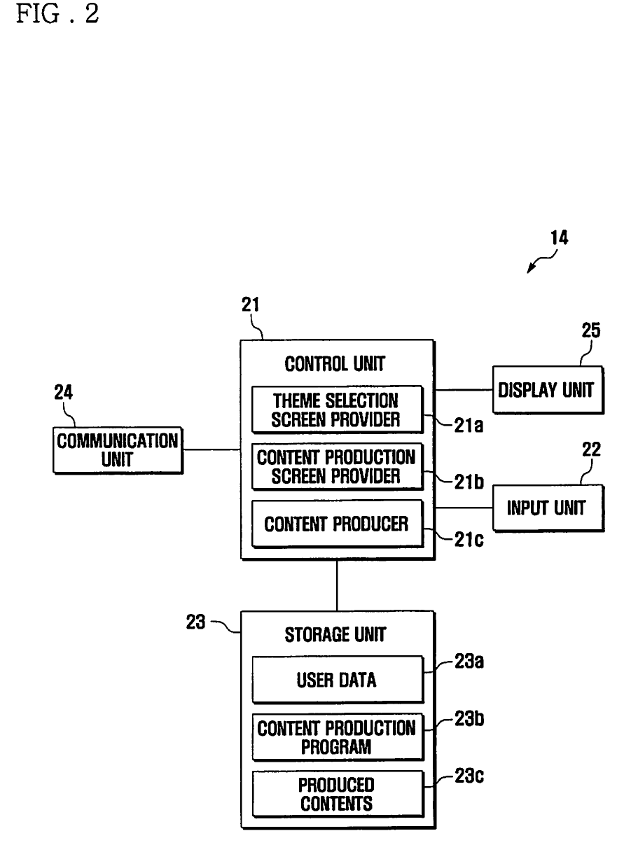

Referring to FIGS. 1 and 2, a content production system 100 includes a mobile terminal 12, a content production apparatus 14, and a web server 16. The mobile terminal 12, content production apparatus 14, and web server 16 can be connected to a communication network 18 through wired or wireless links. The communication network 18 includes a legacy telephone network, a cable network, an optical network, a wireless network, a Packet Switched Network (PSN), an Integrated Services Digital Network (ISDN), a Broadband ISDN (B-ISDN), etc.

The mobile terminal 12 has contents. Each content is stored with information including created and updated times.

The content production apparatus 14 can exchange contents with the mobile terminal 12 and process the contents with user data 23a so as to create a new content. The user data 23a is stored in the content production apparatus 14 and includes internal data installed by a manufacturer of the content production apparatus 14 and external data input by the user. The external data include the contents received from the mobile terminal 12, web data received from the web server 16, and other multimedia data input from other digital devices and storage media. The user data 23a includes still and motion pictures, sounds, and text files.

The web server 16 is connected to the mobile terminal 12 and the content production apparatus 14 via the communication network 18 and provides various multimedia data such as still pictures and motion pictures, sounds, and text files that can be used for producing contents.

Particularly, the content production device 14 for creating contents using the user data 23a can be integrated into the mobile terminal 12. The content production device 14 includes a control unit 21, an input unit 22, a storage unit 23, a communication unit 24, and a display unit 25. In this embodiment, the content production apparatus 14 is a personal computer.

The control unit 21 controls general operations of the content production apparatus. Particularly, the control unit 21 controls the content production in a content production mode.

The input unit 22 is provided with a plurality of keys for manipulating the content production apparatus 14 and generates and transfers a key signal in response to a key selection. Particularly, the input unit 22 provides a key for executing the content production mode. The input unit 22 includes a keyboard 22a and a mouse 22b. The key signal can be generated using the mouse 22a by clicking a mouse button while a mouse pointer 51 is positioned at an area on a screen of the display unit 25.

The storage unit 23 stores application programs for operating the content production apparatus and application data generated by the application programs. More specifically, the storage unit 23 stores the user data 23a and a content production application 23b for producing contents using the user data 23a, and the contents 23c generated by the content production application 23b.

The communication unit 24 provides communication interfaces for the mobile terminal 12 and the web server 16. The communication interfaces include a Universal Serial Bus (USB) port for a USB connection to the mobile terminal 12 and a Network Interface Card (NIC) for an Internet Protocol connection to the web server 16. In order to access webpages provided by the web server 16, a web browser is installed in the content production apparatus 14. The network interface card can be a Local Area Network (LAN) card and a Wireless LAN (WLAN) card. The communication interfaces can be a software-assisted interface.

The display unit 25 displays menu screens associated with various applications and application data stored in the storage unit 23. Particularly, the display unit 25 is configured to display a content production application screen 40 in the content production mode. The display unit 25 can be implemented with a Cathode Ray Tube (CRT) monitor and a flat panel display such as Liquid Crystal Display (LCD) is panel. In a case that an LCD panel is used, the display unit 25 can be implemented with touchscreen functionality so as to be a part of the input unit 22.

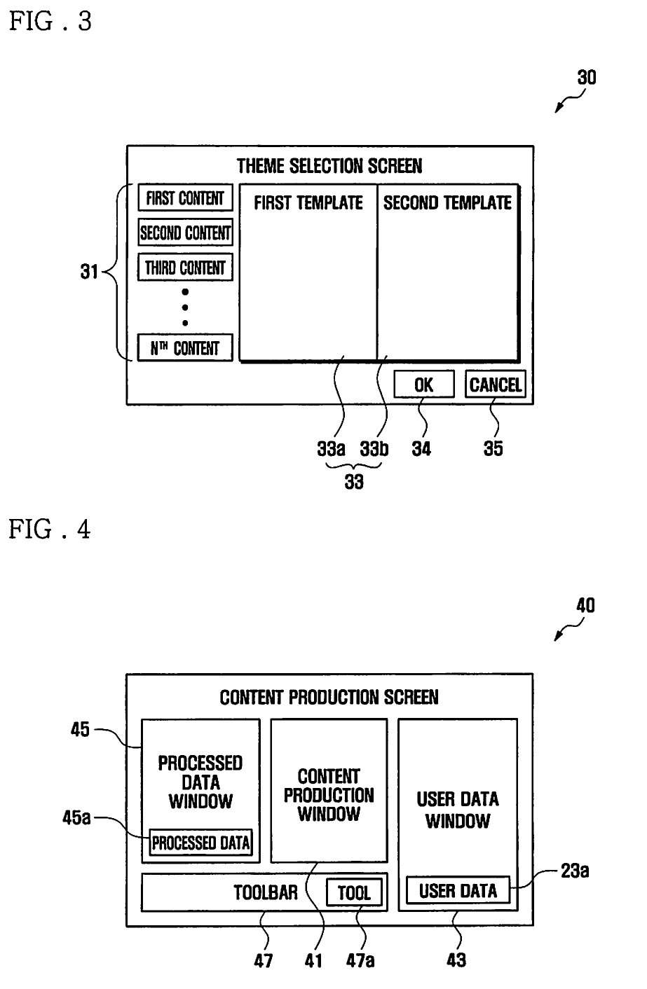

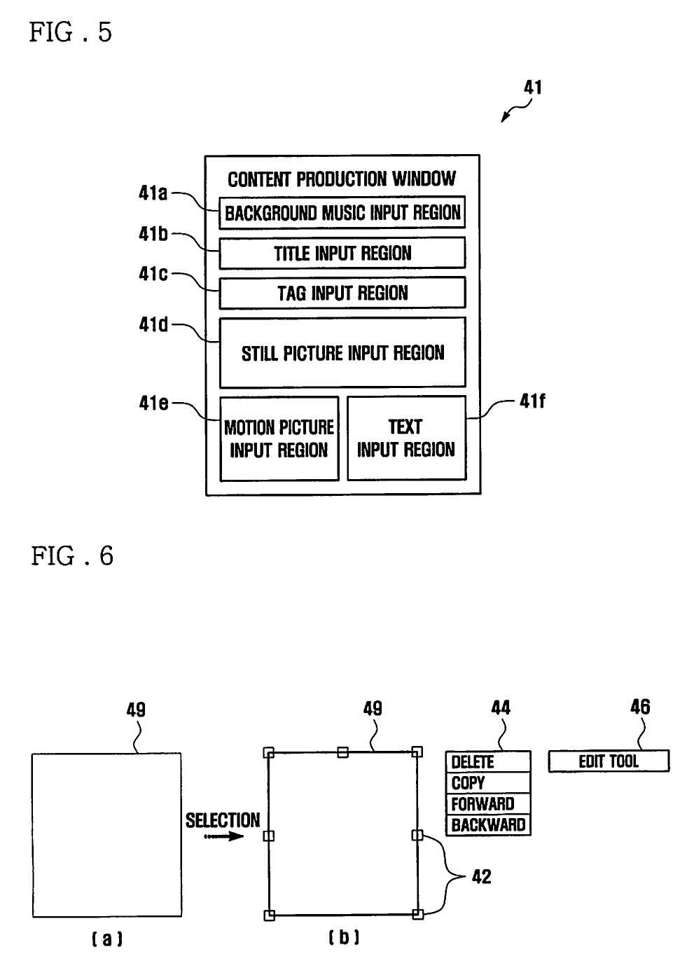

The control unit 21 includes a theme selection screen provider 21a, a content production screen provider 21b, and a content producer 21c. The theme selection screen provider 21a provides a theme selection screen 30 on which a user can select a subject 31 and a template 33 as shown in FIG. 3. The content production screen provider 21b provides a content production screen 40 on which the subject 31 and template 33 selected on the theme selection screen 30 are reflected as shown in FIG. 4. The content production screen 40 includes a content production window 41 and a user data window 43 arranging items obtained by processing the user data 23a. The content producer 21c places the content selected by the user in the content production window 41 and produces contents. The content production screen 40 is composed of the items of the user data 23a and processed data 45a obtained by processed the user data 23a.

As shown in FIG. 3, the theme selection screen 30 includes a subject list region listing subjects 31 at a left side of the theme selection screen 30 and a template window 33 for previewing templates 33a and 33b associated with the subject selected from the subject list region across the center and right side of the theme selection screen 30. Also, the theme selection screen 30 provides “confirm” and “cancel” buttons at the bottom for confirming and canceling a selection of a subject.

In the template window 33, are first and second templates 33a and 33b. Preferably, the first template 33a has a blank layout and the second template 33b has a pre-developed layout for assisting production of contents.

As shown in FIG. 4, the content production screen 40 includes a content production window 41, a user data window 43, a processed data window 45, and a toolbar 47. The user data window 43 presents user data items 23a in a temporal order, and the processed data window 45 presents processed data items 45a. The toolbar 47 is provided with tool icons 47a for executing corresponding tools for editing objects arranged in the content production window 41.

If the first template 33a is selected, a blank page is presented in the content production window 41. If the second template 33b is selected, a pre-developed page is presented in the content production window 41.

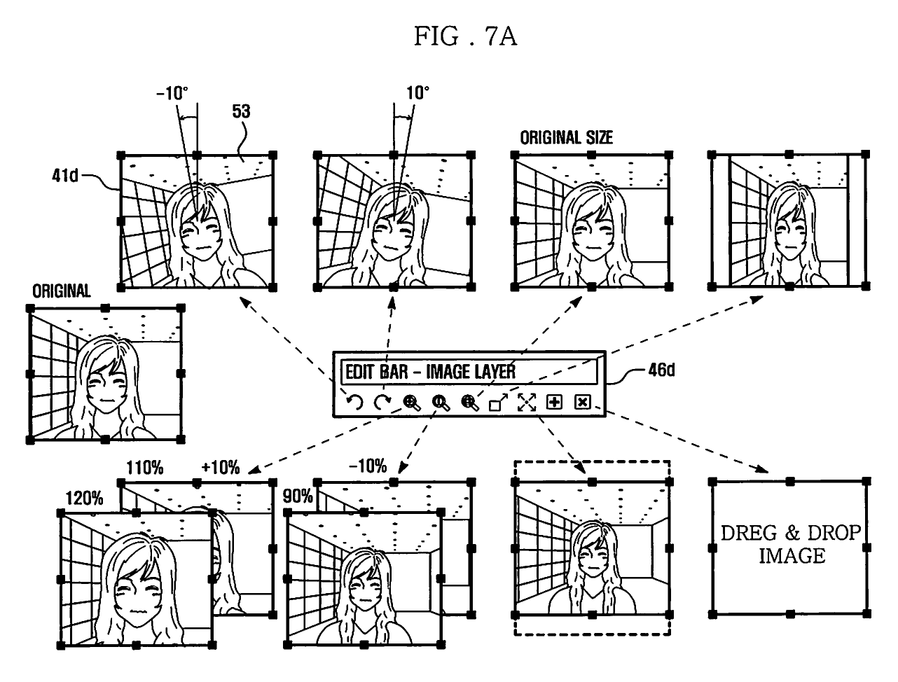

As shown in FIG. 5, the content production window 41 is composed of a background music input region 41a, a title input region 41b, a tag input region 41c, a still picture input region 41d, a motion picture input region 41e, and a text input region 41f.

The items presented in the user data window and the processed data window can be moved into the content production window 41 in a drag and drop manner, i.e., each item dragged from the user data window 43 or the processed data window 45 is presented in the content production window 41 at a position where the item is dropped. In a case that the content production window 41 is composed of a plurality of editable regions, the item is automatically dropped at an editable region designated for a type of the item.

The user data item 23a selected from the user data window is presented in the corresponding editable region of the content production window 41 so as to fit for the region in size. The processed data item 45a dragged from the processed data window 45 can be presented in the corresponding editable region in the same manner as the user data item 23a or presented in a reprocessed form such as a table or a graph.

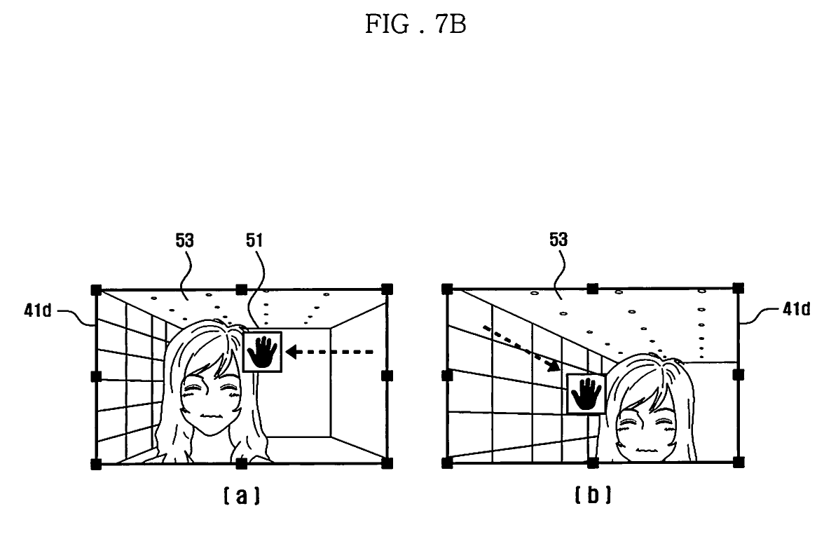

Referring to FIG. 6, if an editable region 49 of the content production window 41 is selected, the content production screen provider 21b presents tool box 46 listing tools that can be used in the selected editable region 49. If an editable region 49 is selected by the pointer, a boundary line of the editable region will be highlighted to indicate the selection. The boundary line is highlighted with several markers enabling a resizing of the editable region 49 such that the size of the editable region 49 can be adjusted by holding and dragging a marker 42 using the pointer. Each tool is used for editing the item is presented in the editable region 49. The tool selected in FIG. 6 provides menu options in accordance with a right click action of the pointer. In an example of this embodiment, the menu options include “delete”, “copy”, “backward”, and “forward”.

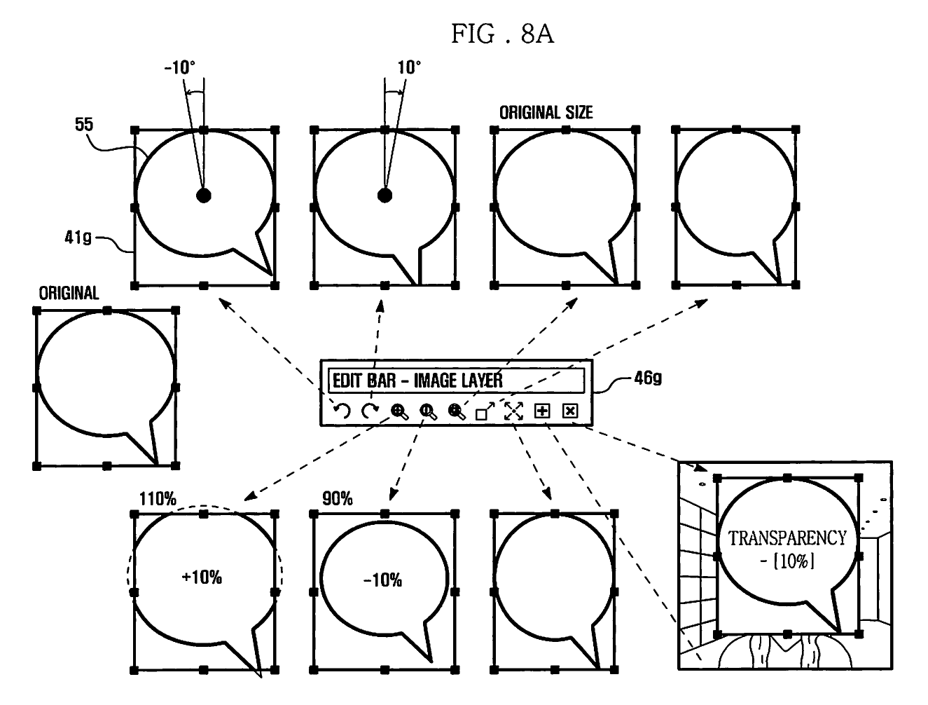

Referring to FIG. 7A, an edit tool 46d is provided with “clockwise rotation”, “counterclockwise rotation”, “zoom-in”, “zoom-out”, “actual size”, “resize”, “import”, and “export” tools. If a specific tool is selected from the tool box 46d while the still picture region 41d is highlighted, an effect of the selected tool is reflected to the item i.e. a picture, presented in the still picture region 41d. For example, the counterclockwise rotation tool rotates the item at an angle of −10 degree in the counterclockwise direction whenever it is selected.

The still picture 53 can be dragged to move the still picture region 41d using a hand tool as shown in FIG. 7B.

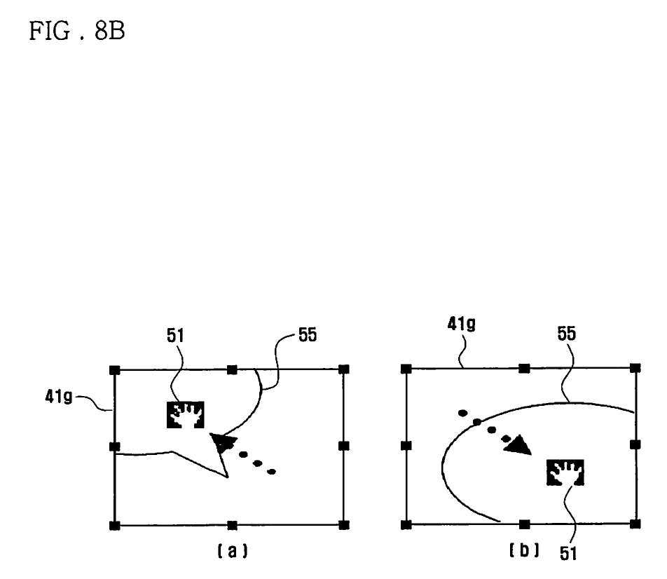

Referring to FIG. 8A, a text balloon tool box 46g is provided with “clockwise rotation”, “counterclockwise rotation”, “zoom-in”, “zoom-out”, “actual size”, “resize”, “transparency up”, and “transparency down” tools. If a specific tool is selected from the text balloon tool box 46g while an editable region 41g is highlighted, an effect of the selected tool is reflected to the text balloon. For example, the counterclockwise rotation tool rotates the item at an angle of −10 degree in the counterclockwise direction whenever it is selected.

As shown in FIG. 8B, the text balloon 55 can be moved in an editable region 51g by dragging the text balloon 55 using the hand tool 51. The text balloon moves in the dragging direction.

In a case that the motion picture region 41e is selected, a motion picture edit tool box is presented with “zoom-in”, “zoom-out”, “actual size”, “resize”, “fill” “import”, and “export” tools. If the text region 41f is selected, a text edit tool box is presented with “arrange left”, “arrange center”, “arrange right”, “arrange both sides”, “reduce line space”, “increase line space” tools.

Although the content production apparatus 14 is implemented with a personal computer, the present invention is not limited thereto. for example, the content production apparatus 14 can be incorporated into a mobile terminal or a web server.

Content Production Method

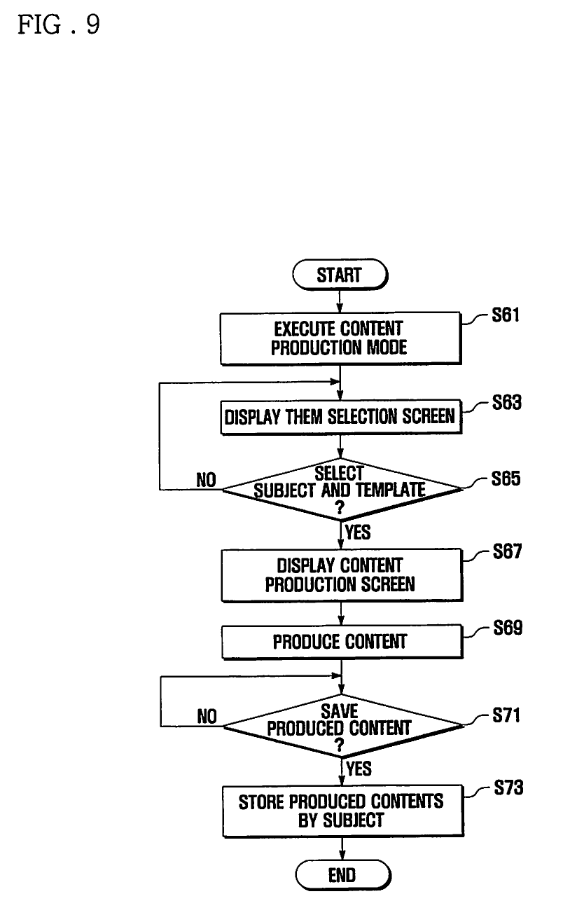

Referring to FIGS. 1 to 5 and 9, if a content production mode is enabled, in step S61, the content production apparatus 14 displays the theme selection screen 30 on the display unit 25, in step S63. The theme selection screen 30 presents subjects 31 and templates 33 for assisting a production of content.

Next, the content production apparatus 14 detects whether a subject and a template are selected from the theme selection screen, in step S65. The subject and template are selected using the pointer 51 by a user.

If it is detected that a subject and a template are selected, the content production apparatus 14 displays the content production screen 40 on the display unit 25, in step S67. The content production screen 40 is provided with the content production window 41, the user data window 43, and the processed data window 45.

If a content production screen 40 is selected, the content production apparatus 14 highlights the content production window 41 and presents draft contents having items selected from the user data window 43 and the processed data window 45, in step S69. The items are moved in a drag and drop manner. That is, each item dragged from the user data window 43 or the processed data window 45 is presented in the content production window 41 at a position where the item is dropped. In a case that the content production window 41 is composed of a plurality of editable regions (41a to 41f), the item is automatically dropped at an editable region designated for a type of the item.

For example, if a music file as the user data item 23a is dragged from the user data window 43 and dropped at the background music input region 41a, the content production apparatus 14 sets the selected music file as the background music of the content to be produced and presents information of the background music in the background music input region 41a. Also, the content production apparatus 14 receives key inputs for the title region 41b and tag input region 41c and arranges still and motion pictures and texts dragged from the user data window 43 and the processed data window 45 and dropped in the respective editable regions.

The user data item to be filled in the text region 41f can be obtained from a voice communication, a Short Message Service (SMS) message, an e-mail, a memo, a scheduler, a personal information management system (PIMS) data. Also, the text can be typed by the user in the text region 41f.

The items can be arranged in the content production window 41 can be presented in the form of object images.

The items presented in the respective editable regions 41a to 41f can be edited using the edit tools presented when a specific region is selected. The processed data items 45a arranged in the content production window 41 can be presented in the form of object images.

After the draft content is produced, the content production apparatus 14 detects whether a key signal for storing the draft content is input, in step S71. If a key signal for storing the draft content is detected, the content production apparatus 14 stores the draft content in the storage unit 23 by subject.

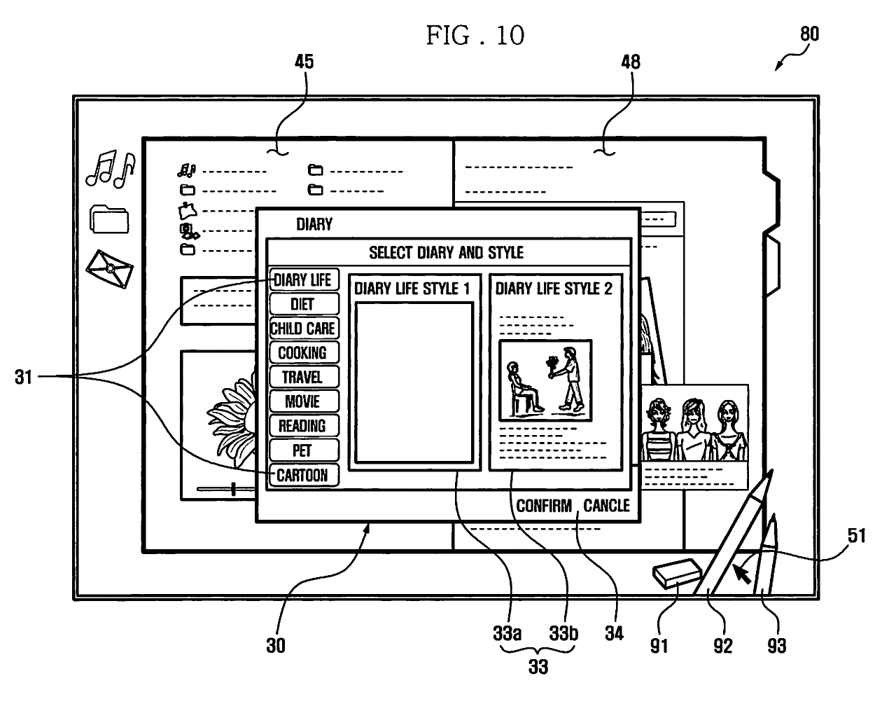

As shown in FIG. 10, if a content production mode is executed, a theme selection screen 30 is presented on a main application window 80. In FIG. 10, a diary related content is depicted as an example. A plurality of subject items 31 are listed at the left side of the theme selection screen 30 and the first and second templates 33a and 33b associated with a selected subject item is presented at the right side of the subject items 31. The sub items include “daily life”, “diet”, “child care”, “cooking”, “travel”, “reading”, “pet”, “cartoon”, etc. In this example, the subject item “daily life” is selected and a template “daily life style2” is presented as the second template 33b.

The content production mode is enabled by selecting a long pencil icon 92 between an eraser icon 91 and a short pencil icon 93 presented at bottom left of the main application window 80. The eraser icon 91 activates an erasing function, and the short pencil icon activates an editing function. The main application window 80 has a layout of an unfolded diary. The left page of the diary shows a processed data 45a and the right page of the diary shows a “to do” list 48 of a day. That is, the left page is provided for the processed data window 45.

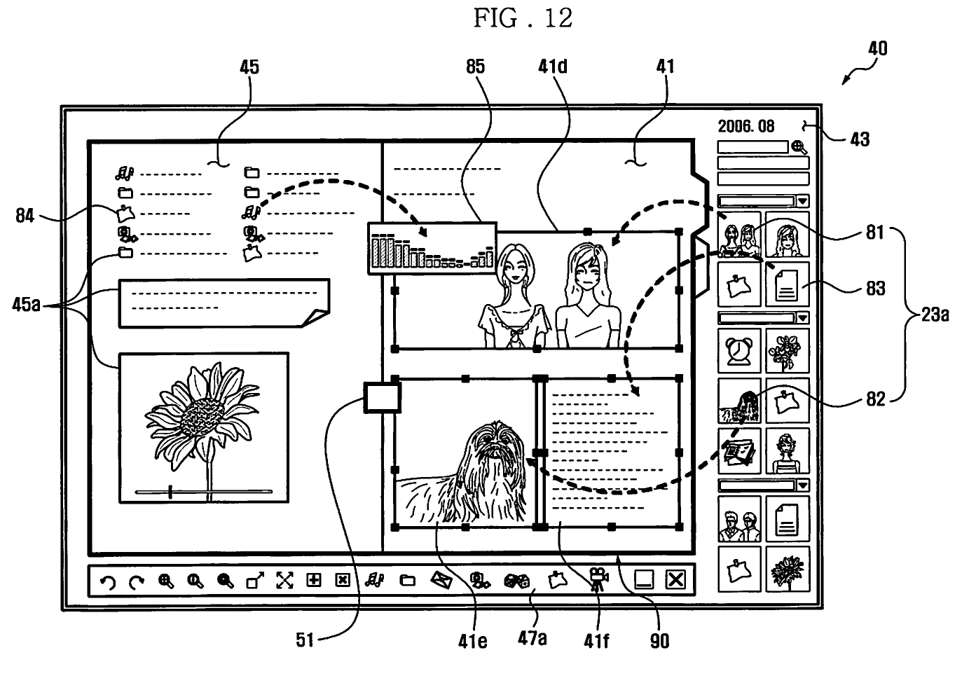

As shown in FIG. 12, the processed data 45a is composed of various information obtained by analyzing daily data received from mobile terminal. For example, the processed data 84 include a usage pattern, “human relationship”, “characters in my life”, and a calendar. The usage pattern is presented in the form of a list of the daily data by type with the number of each data type. The data types include SMS messages, Multimedia Messaging Service (MMS) messages, movies, photos, and other downloaded contents. The “human relationship” is measured by counting the amounts of data exchanged with other persons and presented in the form of a text or an icon. The today's content lists the photos and movies played by the mobile terminal in temporal order. The “characters in my life” ranks the persons keeping in touch according to the data exchange amount and lists the persons by rank.

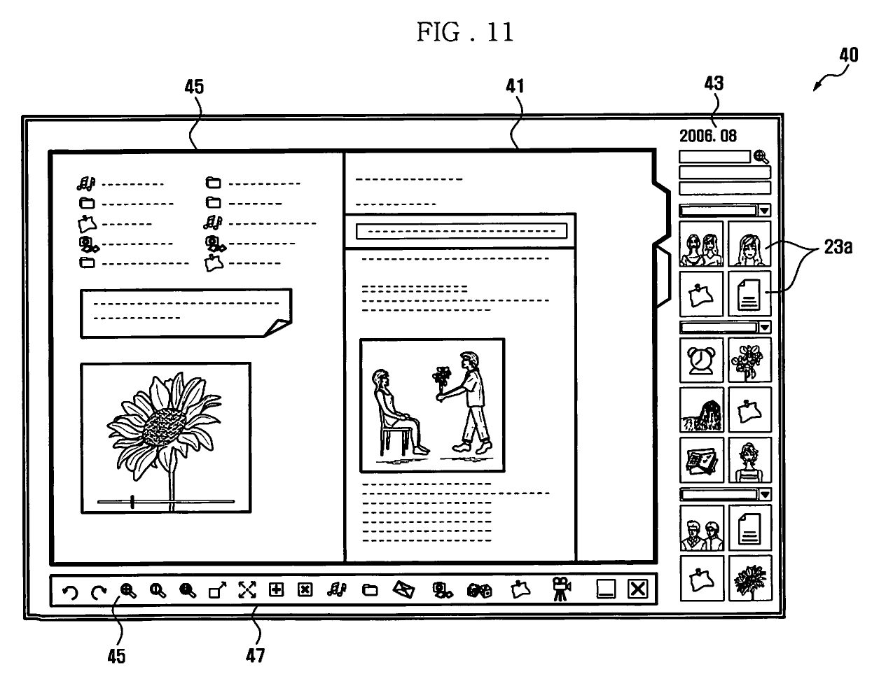

If a subject 31 and a template 33 associated with the subject 31 are selected on the theme selection screen 30, the content production screen 40 is displayed as shown in FIG. 11. On the right page of the diary of the unfolded diary of the main screen, the content production window 41 filled by the selected template 33 is presented. At the right side of the content production window 42, a user data window 43 is arranged. The user data window 43 presents the user data items 23a classified by type are listed in temporal order. The user data window 43 shows the user data items used in a predetermined period. The period can be a day. The type includes voice communication, SMS message, MMS message, movie, photo, sound, and other downloaded contents. The user data items 23a can be represented by icons expressing the characteristics of the data. Particularly, the movie and photo can be presented in the form of a thumbnail.

Below the processed data window 45 and the content production window 41, a toolbar 47 is arranged and the toolbar 47 is composed of tools 47a. The tools 47a include the tools such as text, photo, movie, pencil, text balloon, and drawing tools.

As shown in FIG. 12, content 23c is produced by moving the items from the user data window 43 and the processed data window 45 to the content production window 41 in the drag and drop manner. For example, a picture 81, a movie 82, and an email 83 of a specific date are dragged from the user data region 43 and dropped in still picture region 41d, motion picture region 41e, and text region 41f, respectively. Also, a specific processed data item 45a is dragged from the processed data window 45 and dropped in the content production window 41 so as to be presented as an object image 85. The object image 85 can be presented in the form of a bar graph. At this time, the processed data 45a can be displayed in the form of lists arranged by type.

As described above, the content production apparatus and method of the present invention enables producing content by selecting a subject and a template associated with the subject and arranging user data items on the template, thereby facilitating to produce a useful content.

Also, the content production apparatus and method of the present invention are advantageous in production of a content since the content can be produced by selecting a subject and a template associated with the subject and arranging items selected from a user data window and a processed window in a single theme selection screen in the drag and drop manner.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A content production method comprising:
displaying a theme selection screen including subjects and templates associated with the subjects;
displaying a content production screen including a content production window composed of a template associated with a subject selected on the theme selection screen and items generated through using user data; and
producing at least one of content by arranging at least one of the items on the template.

2. The content production method of claim 1, wherein the content production window comprises at least one of editable regions including a background music input region, a title input region, a tag input region, a still picture input region, a motion picture input region, and a text input region.

3. The content production method of claim 2, wherein the items comprise raw data items and processed data items obtained by processing the raw data items.

4. The content production method of claim 3, wherein the content production screen further comprises:
a raw data window arranged at a side of the content production window for listing the raw data items;
a processed data window arranged at a side of the content production window for listing the processed data items; and
a toolbar arranged at a side of the content production window for presenting tools.

5. The content production method of claim 4, wherein producing content comprises moving at least one of the items listed in the raw data window and the processed data window onto the content production window in a drag and drop manner.

6. The content production method of claim 5, wherein producing content comprises placing the dragged item at one of the editable regions.

7. The content production method of claim 5, wherein producing content comprises:
if the item is a music file, placing the item at the background music input region;
if the item is a still picture, placing the item at the still picture input region;
if the item is a motion picture, placing the item at the motion picture input region; and
if the item is one of a voice communication, a short message, an e-mail, a memo, a schedule, and personal information management system data, placing the item at the text input region.

8. The content production method of claim 5, wherein producing a content comprises, if an editable region is selected, displaying an editing tool box presenting tools that can be used in the editable region.

9. The content production method of claim 8, further comprising classifying and storing the produced contents by subject.

10. A content production apparatus comprising:
a theme selection screen provider for providing a theme selection screen including subjects and templates associated with the subjects;
a content production screen provider for providing a content production screen including a content production window composed of a template associated with a subject selected on the theme selection screen and items generated through using user data; and
a content producer for producing at least one content by arranging at least one of the items on the template.

11. The content production apparatus of claim 10, wherein the content production window comprises at least one of editable regions including a background music input region, a title input region, a tag input region, a still picture input region, a motion picture input region, and a text input region.

12. The content production apparatus of claim 11, wherein the items comprise raw data items and processed data items obtained by processing the raw data items.

13. The content production apparatus of claim 12, wherein the content production screen further comprises:
a raw data window arranged at a side of the content production window for listing the raw data items;
a processed data window arranged at a side of the content production window for listing the processed data items; and
a toolbar arranged at a side of the content production window for presenting tools.

14. The content production apparatus of claim 13, wherein the items listed in the raw data window and the processed data window are moved by onto the content production window in a drag and drop manner.

15. The content production apparatus of claim 14, wherein the content producer places the dragged item at one of the editable regions.

16. The content production apparatus of claim 15, wherein the content producer places, if the item is a music file, the item at the background music input region; if the item is a still picture, at the still picture input region; if the item is a motion picture, at the motion picture input region; and if the item is one of a voice communication, a short message, an e-mail, a memo, a schedule, and personal information management system data, at the text input region.

17. The content production apparatus of claim 16, wherein if an editable region is selected, the content producer displays an editing tool box presenting tools that can be used in the editable region.

18. The content production apparatus of claim 17, further comprises a storage for storing the produced contents by subject.
